(19) United States
(12) Patent Application Publication
(10) Pub. No.: US 2009/0024880 A1
(43) Pub. Date: Jan. 22, 2009

(54) System and method for triggering control over abnormal program termination

(76) Inventor: Udo Klein, Maximiliansau (DE)

Correspondence Address: KENYON & KENYON LLP, ONE BROADWAY, NEW YORK, NY, 10004, US

(21) Appl. No.: 11/879,955

(22) Filed: Jul. 18, 2007

(51) Int. Cl. G06F 11/07

(52) U.S. Cl. 714/49; 714/E11.021

(57) ABSTRACT

Methods and systems for handling errors in applications are provided. A comparison may be executed to confirm that actual results are in accordance with expected results. If the comparison results in an application error, a special execution software object is executed. The special execution software object obtains and maintains a copy of the application context associated with the application error found. A user may then view the application context to determine the source of the error. A logbook may be maintained to store all of the application errors and associated application contexts.

Modern firms use complex business systems to define and perform the business processes used by the firms. The business system typically includes a variety of backend applications to perform related tasks and define related processes, such as inventory management, employee management, customer relations, etc. Each application makes use of a variety of software objects, which contain data and business logic to manipulate the data. In business software environments, such as in enterprise service architecture systems, those software objects may be referred to as business objects which can be defined according to a node structure that may specify corresponding data elements and behaviors to be associated with the business objects.

Generally, the user does not see all of the inner workings of business tasks and processes which leads to the question of suitability of fault tolerant provisions. For example, a business employee may be reviewing a stack of 200 accounting documents in the electronic system and may observe a questionable result. In such a situation, the employee would wish to figure out where the error is in the context of the application itself. For example, the employee would wish to know if the error is in the text, calculations, client listing, etc. Previously, in the case of an error, the business employee would either alert the system, or the system would perform its own automatic fault tolerance testing, and while an error report may be generated, the erroneous result along with the details regarding the error are discarded. In such a case, the employee is unable to determine where the error occurred exactly and in which context.

In another example, the computer conducts its own error testing by adding up the number of records reviewed by the system compared with the predetermined number of records that were supposed to be reviewed by the system. Upon comparing the numbers, the computer may determine that 3 reviewed records does not equal the 4 to-be-reviewed records amount, and the computer may dump the results and begin the process again. Further, an error message may be sent to a logbook or other location indicating the number of reviewed records upon the dumping of the results. In such situations, only the presence of the error, and not the reason or context for the error is identified.

One previously considered approach included sending a special error message into the application message channel. However, this approach did not work for where a message handler is valid for the situation. In addition, messages are a means of communication with users, and not a mechanism to indicate corrupted system situations. Such messages also may be limited in the number of string parameters they are allowed to express, which may not sufficiently explain the context of the error.

Another previously considered approach included implementing ASSERT statements. ASSERT statements may be coded by system administrators, and the statements have the desired semantics of indicating abnormal system operation. However, if a user violates an assertion, an automatic dump occurs thus clearing the application memory. So, the application context in the event of an error will not be retrievable nor available for analysis.

Another previously considered approach included calling a special termination method. Such a call is codeable by a system administrator. However, coding a call to a special termination method will establish a “hard” link to the support mechanism. Thus, the support mechanism must remain always available and the applications are tightly coupled to it. If the mechanism were later improved or changed, there would be no easy way to substitute a new mechanism for the old mechanism due to those tight coupling and dependencies.

Accordingly, there exists a need for an embedded support mechanism which will be used to retrieve an application context prior to creating a support message, or at the very least, prior to dumping the erroneous results, and thus, application context.

### BRIEF DESCRIPTION OF THE DRAWINGS

FIG. 1 shows an example embedded support mechanism according to an embodiment of the present invention.

FIG. 2 shows an example request and service execution according to an embodiment of the present invention.

FIG. 3 shows an exemplary trigger mechanism according to an embodiment of the invention.

FIG. 4 shows an example embodiment of the present invention.

FIG. 5 shows another example embodiment of the present invention.

### DETAILED DESCRIPTION

Methods and systems for providing an embedded context support mechanism which may be used to retrieve application context prior to creating support messages (which may cause a dumping of the application context) are discussed in various embodiments below. In embodiments of the present invention, the context support mechanism has at least one of the various properties: easy to call from an application point of view; possibility to retrieve an application context before the kernel will wipe out application memory; guarantee that an application cannot continue after the context is retrieved; loose coupling with any “context retrieval” mechanism, e.g., late binding at runtime; and ease of extension to additional parameters.

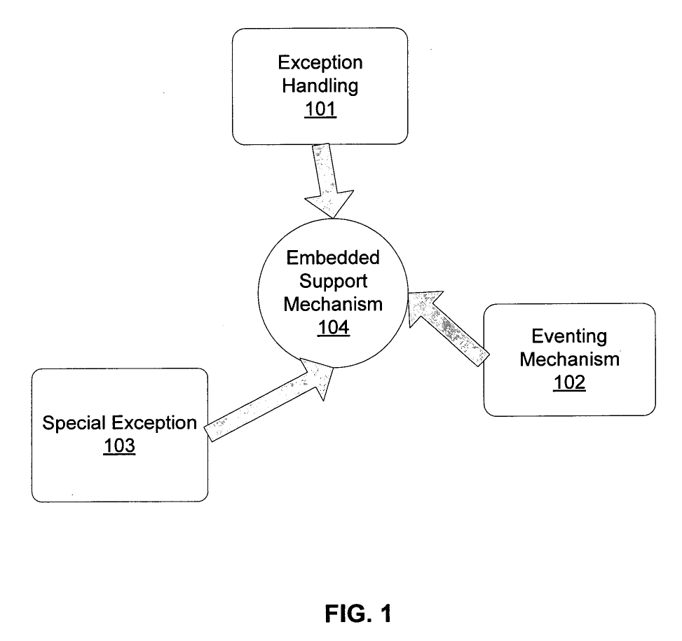

FIG. 1 shows an example embodiment of an embedded support mechanism in accordance with the present invention. An example support mechanism 104 is comprised of a combination of an exception handling mechanism 101, an eventing mechanism 102, and a properly placed special exception statement 103.

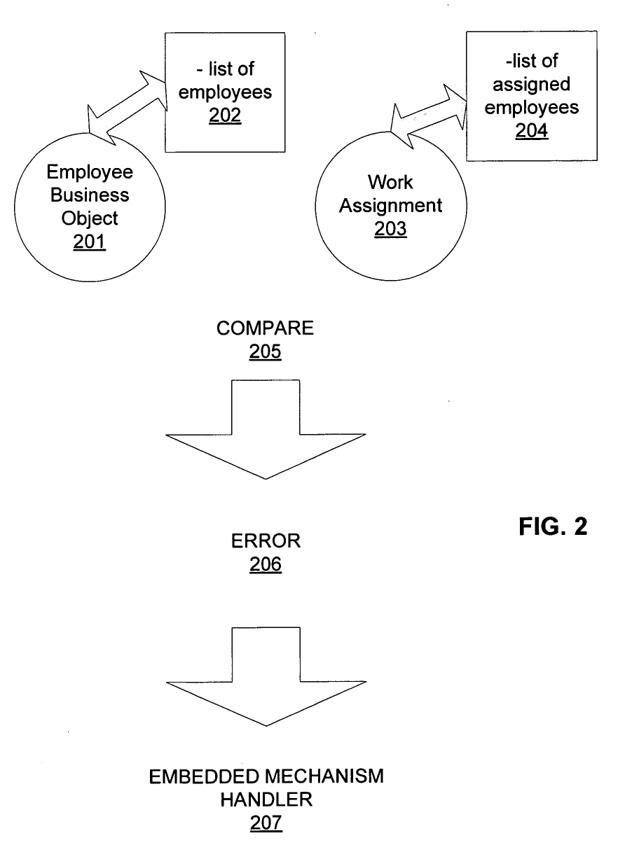

FIG. 2 shows an example situation warranting attention from the support mechanism. For example, an employee business object 201 is associated with a list of employees 202. A work assignment list business object 203 is associated with a list of employees 204 assigned to projects. If the system checks 205 to make sure that the number of employees in, e.g., a buffered list from the business object, is equal to the number of employees assigned to projects, and the comparison results in an error 206, then one can manually call the object to check the state of the employee business object, e.g., get the application context via a user interface. However, since this information is not useful to the task, it may get dumped. If a user attempts to redirect the application context to the user interface, the business object may be dumped. There is no guarantee. So, instead of an ASSERT statement, an embodiment of the present invention involves using a fatal exception 207 where each exception is an object. A user may open a second database and manipulate the information without losing the material by a dump of the system.

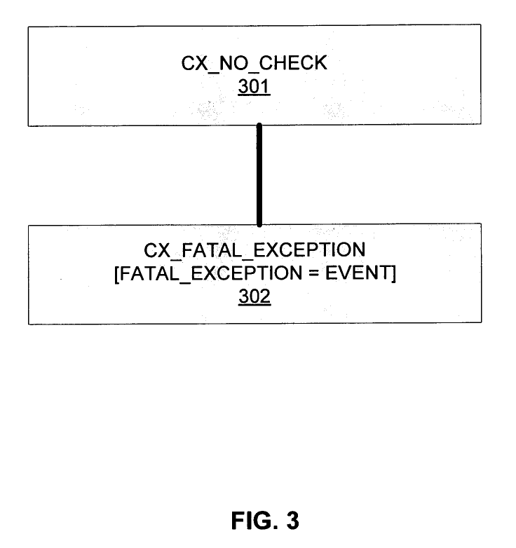

FIG. 3 shows an exemplary special exception (e.g., CX_FATAL_EXCEPTION) 302 which is provided for the triggering of any controlled abnormal termination. The exception will be inherited from a function (e.g., CX_NO_CHECK) 301 so that applications need not declare it, and so that it may trigger anywhere. An event (e.g., FATAL_EXCEPTION) is triggered inside the constructor of the exception. Thus, any context retrieval mechanism can register to this event, e.g., FATAL_EXCEPTION, and thus retrieve the application context if desired. This method completely decouples the context retrieval from the trigger because we do not know in advance what context retrieval mechanism will be triggered. In an embodiment, it may happen that no mechanism is triggered. The context retrievers must register an exception. This mechanism can be implemented using normal coding languages, e.g. ABAP. For example, in the situation when using the ABAP statements from a kernel point of view, the kernel will not wipe out any application memory while this is running.

In an embodiment of the present invention, an always violated assertion may be coded (e.g., ASSERT 0>0) to enforce termination. This will assist since such always violated assertions may not be apparent.

In an embodiment of the present invention, if an extension is required, an extension can be achieved by inheriting from CX_FATAL_EXCEPTION in order to add attributes as desired by the applications. In a further embodiment, in a first implementation, CX_FATAL_EXCEPTION should be implemented “final” to inhibit extensions by applications. Such a “final” flag can be removed later to allow for such extensions if desired.

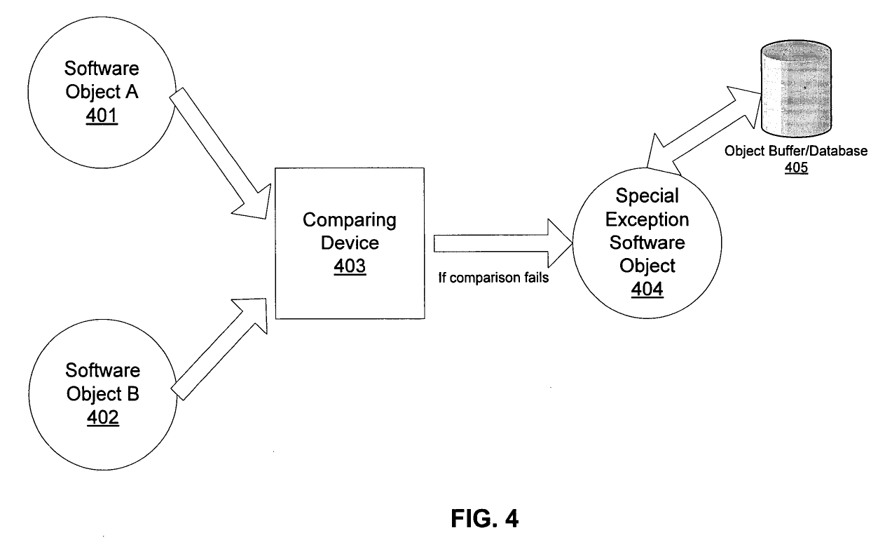

FIG. 4 shows software object A 401 and software object B 402. Software object A 401 contains predetermined result(s) or standard information (e.g., list of employees). Software object B 402 contains the determined actual runtime result(s) or information. The comparing device 403 compares the data of the two objects to determine if they match. For example, a table or database may include information to alert the comparing device to compare the information of the two objects. Or, an attribute of the object(s) may identify the related object for later comparison purposes. The comparing device 403 may observe in a look-up table or database what a “fail” or “pass” means, or may just check whether a value from software object A equals the value from software object B. In a further embodiment, software object B 402 may check its runtime value against a value in a look-up table or database, thus not needed software object A 401.

If the comparison of the results or values or information fails, then a special exception software object 404 or a similar object is created to store the application context of the error causing the failure. The object may store this information in a temporary buffer or database 405. In a further embodiment, the special exception software object causes a dump of the software object B 402. The special exception software object may maintain a copy of the information in its buffer or database, depending upon the administrator's/user's predefined or dynamic instructions. In a further embodiment, a message may be sent to a logbook and/or to a user to indicate the failure and application context.

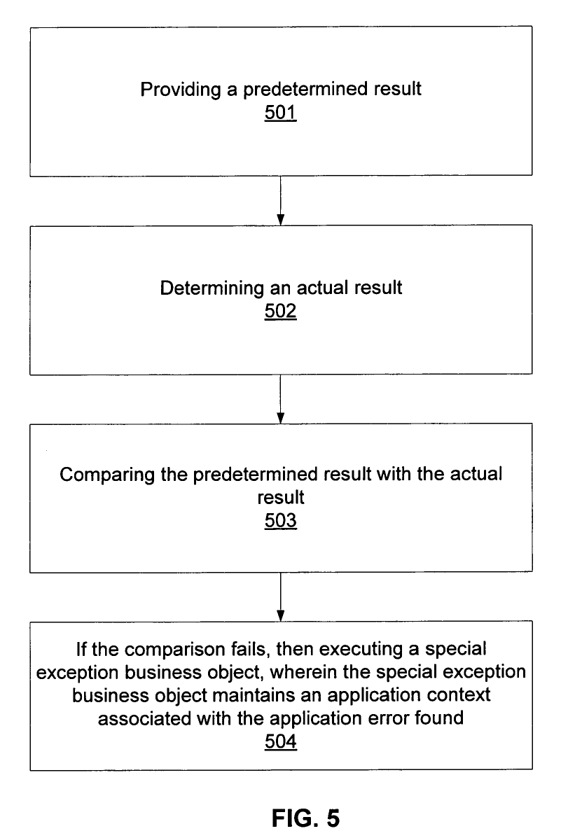

FIG. 5 shows an exemplary method according to an embodiment of the present invention. In step 501, a predetermined result is provided to the system. This predetermined result may be in the form of information associated with a software object. In step 502, an actual result is determined or obtained. This actual result may be in the form of information associated with another software object. In step 503, the two results are compared. In step 504, if the comparison fails, then a special exception business object is executed to maintain the application context associated with the application error found.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CDR, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for observing an application error, comprising:
providing a predetermined result;
determining an actual result;
comparing the predetermined result with the actual result;
if the predetermined result does not equal the actual result, then executing a special exception business object, wherein the special exception business object maintains an application context associated with the application error found.

2. The method of claim 1, wherein the predetermined result is supplied by a first business object, and the actual result is supplied by a second business object.

3. The method of claim 1, wherein the special exception object provides for a dump of the actual result by the second business object, and the special exception business object continues to maintain a copy of the application context associated with the application error.

4. The method of claim 3, wherein the copy of the application context associated with the application error is entered in a database.

5. The method of claim 1, wherein the executing the special exception business object is automatic.

6. The method of claim 1, wherein the executing the special exception business object is manually executed.

7. A system for observing an application error context, comprising:
a first software object storing a predetermined result;
a second software object storing an actual runtime result;
a comparing device to compare the predetermined result with the actual runtime result; and
a special exception software object,
wherein, if a comparison of the predetermined result and the actual runtime result results in an error, the special exception software object stores a copy of the actual runtime result and any additional information regarding the context of the error.

8. The system of claim 7, wherein the special exception object provides for a dump of the actual result by the second business object, and the special exception business object continues to maintain a copy of the actual runtime result and any additional information regarding the context of the error.

9. The system of claim 7, wherein the copy of the actual runtime result and any additional information regarding the context of the error is entered in a database.

10. The system of claim 7, wherein the special exception business object is automatically executed upon a finding of the error.

11. The method of claim 7, wherein the special exception business object is manually executed upon finding of the error.

12. A computer-readable medium including instructions adapted to execute a method for observing an application error, the method comprising:
providing a predetermined result;
determining an actual result;
comparing the predetermined result with the actual result;
if the predetermined result does not equal the actual result, then executing a special exception business object, wherein the special exception business object maintains an application context associated with the application error found.

13. The computer-readable medium of claim 12, wherein the predetermined result is supplied by a first business object, and the actual result is supplied by a second business object.

14. The computer-readable medium of claim 12, wherein the special exception object provides for a dump of the actual result by the second business object, and the special exception business object continues to maintain a copy of the application context associated with the application error.

15. The computer-readable medium of claim 14, wherein the copy of the application context associated with the application error is entered in a database.

16. The computer-readable medium of claim 12, wherein the executing the special exception business object is automatic.

17. The computer-readable medium of claim 12, wherein the executing the special exception business object is manually executed.
